(19) United States
(12) Patent Application Publication
(10) Pub. No.: US 2024/0224178 A1
(43) Pub. Date: Jul. 4, 2024

(54) CUSTOMER PREMISES EQUIPMENT

(71) Applicant: NTT DOCOMO, INC., Tokyo (JP)

(72) Inventors: Wenjia Liu, Beijing (CN); Jing Wang, Beijing (CN); Weiqi Sun, Beijing (CN); Xiaolin Hou, Beijing (CN); Lan Chen, Beijing (CN); Yuki Hokazono, Tokyo (JP)

(73) Assignee: NTT DOCOMO, INC., Tokyo (JP)

(21) Appl. No.: 18/557,799

(22) PCT Filed: May 10, 2021
(86) PCT No.: PCT/CN2021/092889

§ 371 Date: Oct. 27, 2023

(51) Int. Cl. H04W 52/02; H04B 7/185

(52) U.S. Cl. CPC H04W 52/0225; H04B 7/18504

(57) ABSTRACT

A customer premises equipment (CPE), includes: a receiving unit configured to receive at least one of traffic load information and configuration information, a control unit configured to determine that the customer premises equipment enters an on state or a non-on state according to at least one of the traffic load information and the configuration information, wherein the non-on state at least includes an off state.

### TECHNICAL FIELD

The present invention relates to a customer premises equipment in a next generation mobile communication system and a communication method for the customer premises equipment.

### BACKGROUND

At present, we expect a customer premises equipment (CPE) for a high altitude platform station (HAPS), which uses satellites (e.g., high orbit satellites, medium orbit satellites and low orbit satellites) to communicate with users on the ground. The high altitude platform station can also communicate with users on the ground via a ground Gateway. In Japan, more attention is paid to HAPS at a height of about 20 kilometers from the ground, through which communication services are provided to users on the ground.

Specifically, as shown in FIG. 1, the HAPS provides communication services to users on the ground via the above CPE.

HAPS usually covers a wide area, such as several hundred square kilometers. However, for users on the ground in this area, the traffic related to them is actually very dynamic in a space domain and a time domain, that is to say, the traffic may be larger in one area at a certain time, but it will be larger in another area at the next time.

In addition, the communication between the HAPS and the CPE may interfere with the communication between a terrestrial cellular base station and a user equipment.

Faced with the above situation, the customer premises equipment in an on state in the prior art has problems of high power consumption and low resource utilization rate, and may interfere with other equipment.

### SUMMARY

According to an aspect of the present disclosure, there is provided a customer premises equipment (CPE) comprising: a receiving unit configured to receive at least one of traffic load information and configuration information; a control unit configured to determine that the customer premises equipment enters an on state or a non-on state according to at least one of the traffic load information and the configuration information, wherein the non-on state at least comprises an off state.

As a result, it is possible to increase a resource utilization rate of the customer premises equipment and reduce power consumption and interference.

According to an aspect of the present disclosure, in the off state, the control unit determines, when a condition about the customer premises equipment is met, that the customer premises equipment is switched to another state different from the off state.

As a result, the customer premises equipment is able to respond to changes in the traffic load of a user equipment in time.

According to an aspect of the present disclosure, the receiving unit is further configured to receive the configuration information from a high altitude platform station, and the control unit is further configured to determine in the off state that the customer premises equipment is switched to another state different from the off state according to the configuration information.

As a result, the customer premises equipment is able to respond to changes in the traffic load of the user equipment in time based on the configuration information received from the high altitude platform station, and is able to flexibly control the state of the customer premises equipment.

According to an aspect of the present disclosure, the off state comprises a full off state, the control unit is only used in the full off state for determining that the customer premises equipment is switched to another state different from the full off state.

As a result, the customer premises equipment in the full off state is able to turn off functions other than those used for determining that the customer premises equipment switches to the other state different from the full off state, and thus it is possible to achieve lower power consumption and interference.

According to an aspect of the present disclosure, the off state comprises a semi-off state, the customer premises equipment further comprises: a transmitting unit configured to transmit a reference signal for detecting a traffic load at a predetermined time interval in the semi-off state.

As a result, it is possible to respond faster to changes in the traffic load of the user equipment while achieving lower power consumption to a certain extent.

By further defining the off state as the semi-off state and the full off state, it is possible to respond more flexibly to different cases of the traffic load.

According to an aspect of the present disclosure, in the semi-off state, the transmitting unit is further configured to transmit a traffic load report to a high altitude platform station according to the traffic load information.

As a result, it is possible to enable the high altitude platform station to keep track of changes in the traffic load of the user equipment, thereby enabling the high altitude platform station to control the state of the customer premises equipment based on the changes in the traffic load.

Thus, it is possible to control the state of the customer premises equipment more flexibly.

According to an aspect of the present disclosure, the customer premises equipment further comprises a transmitting unit configured to transmit, after the control unit determines that the customer premises equipment is switched from the off state to the other state different from the off state or after the control unit determines that the customer premises equipment is switched from the other state different from the off state to the off state, information indicating the switched state to the high altitude platform station.

As a result, even if the switching of the state of the customer premises equipment has occurred, it is possible to enable the high altitude platform station to keep abreast of the state in which the customer premises equipment is, thereby providing a basis for the high altitude platform station to control the state of the customer premises equipment.

According to an aspect of the present disclosure, the customer premises equipment is configured as a distributed unit (DU), the high altitude platform station is configured as a central unit (CU).

According to an aspect of the present disclosure, there is provided high altitude platform station (HAPS), comprising: a control unit configured to determine that a customer premises equipment enters an on state or a non-on state, wherein the non-on state at least comprises an off state; a transmitting unit configured to transmit configuration information for indicating the customer premises equipment to enter the on state or the non-on state.

As a result, it is possible to control the state of the customer premises equipment more flexibly, through indicating the customer premises equipment to enter the on state or the non-on state by the high altitude platform station.

According to an aspect of the present disclosure, the high altitude platform station further comprises: a receiving unit configured to receive a traffic load report transmitted from the customer premises equipment, wherein the control unit determines that the customer premises equipment enters the on state or the non-on state based on the traffic load report.

As a result, it is possible to control the state of the customer premises equipment more flexibly and it is possible to respond in time to changes in the traffic load of the user equipment.

### BRIEF DESCRIPTION OF DRAWINGS

The above and other objects, features and advantages of the present disclosure will become more obvious by describing embodiments of the present disclosure in more detail in conjunction with accompanying drawings. The accompanying drawings are provided to provide a further understanding of the embodiments of the present disclosure, constitute a part of the specification, serve to explain the present disclosure together with the embodiments of the present disclosure, and do not constitute a limitation of the present disclosure. In the drawings, like reference numerals usually represent like components or steps.

FIG. 1 is a schematic diagram showing that a high altitude platform station communicates with a user equipment via a customer premises equipment.

FIG. 2 is a schematic diagram showing the customer premises equipment according to an embodiment of the present disclosure.

FIG. 3 is a schematic diagram showing the high altitude platform station according to an embodiment of the present disclosure.

FIG. 4 is a flowchart showing that the customer premises equipment in a full off state determines to switch to another state (e.g., an on state) different from the full off state according to an embodiment of the present disclosure.

FIG. 5 is a flowchart showing that the customer premises equipment in the full off state determines to switch to another state (e.g., an on state) different from the full off state based on configuration information transmitted by the high altitude platform station, according to an embodiment of the present disclosure.

FIG. 6 is a flowchart showing that the customer premises equipment in a semi-off state determines to switch to another state (e.g., an on state) different from the semi-off state, according to an embodiment of the present disclosure.

FIG. 7 is a flowchart showing that the customer premises equipment in the semi-off state determines to switch to another state (e.g., an on state) different from the semi-off state based on configuration information transmitted by the high altitude platform station, according to an embodiment of the present disclosure.

FIG. 8 is a flowchart showing that the customer premises equipment in an idle state determines to switch to another state (e.g., on state) different from the idle state, according to the embodiment of the present disclosure.

FIG. 9 is a schematic diagram of a communication method executed by the customer premises equipment according to an embodiment of the present disclosure.

FIG. 10 is a schematic diagram of a communication method executed by the high altitude platform station according to an embodiment of the present disclosure.

FIG. 11 is a schematic diagram showing a hardware structure of a device according to an embodiment of the present disclosure.

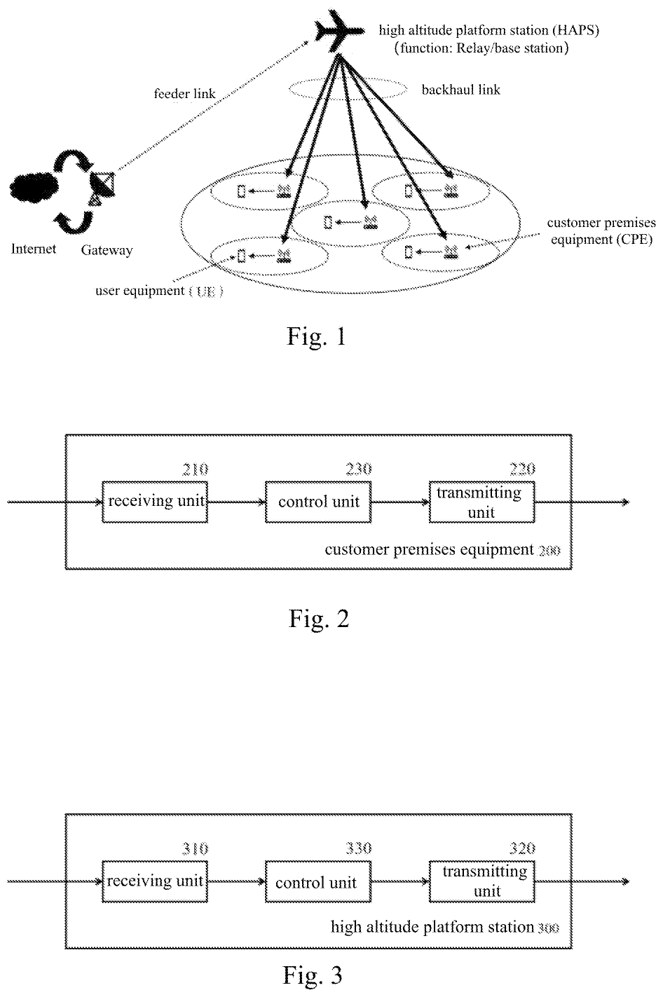

### DETAILED DESCRIPTION

In order to make the objects, technical solutions and advantages of the present disclosure more obvious, exemplary embodiments according to the present disclosure will be described in detail below with reference to the accompanying drawings. Like reference numerals refer to like elements throughout the drawings. It should be appreciated that the embodiments described herein are merely illustrative and should not be construed as limiting the scope of the present disclosure. In addition, Terminals described here may include various types of terminals, such as vehicle terminals, User Equipment (UE), mobile terminals (or mobile stations) or fixed terminals. The base station described here includes eNB, gNB, etc. In addition, the customer premises equipment (CPE) described here can also be configured as a distributed unit (DU). In addition, the high altitude platform station (HAPS) described here can also be configured as a central unit (CU). In addition, the central unit (CU) can also be called the CU of the high altitude platform station. The distributed unit (DU) can also be called the DU of the customer premises equipment. The high altitude platform station can also be configured as a host DU (Donor-DU). The host DU (Donor-DU) can also be called the host DU of high altitude platform station.

According to one example of the present invention, four states of the customer premises equipment can be defined.

For the customer premises equipment, four states are defined: an on state, an idle state, a semi-off state and off state. Each customer premises equipment supports all or part of these four states.

A customer premises equipment (CPE) according to an embodiment of the present disclosure will be described with reference to FIG. 2. FIG. 2 is a schematic diagram of the customer premises equipment according to an embodiment of the present disclosure. As shown in FIG. 2, the customer premises equipment 200 includes a receiving unit 210, a transmitting unit 220 and a control unit 230. The receiving unit 210 receives at least one of traffic load information and configuration information, and the control unit 230 determines that the customer premises equipment 200 enters an on state or a non-on state according to at least one of the received traffic load information and configuration information, wherein the non-on state at least comprises an off state. The non-on state may also comprise an idle state.

The traffic load information may be transmitted from the user equipment to the customer premises equipment, which may represent an instantaneous traffic load of the user equipment at a current time, a traffic load at a specific time, or a cumulative or average value of traffic loads in a specific period. For example, the cumulative or average value of the traffic loads in a period after the current time may also indicate a predicted traffic load at a specific time in the future, and may also indicate a cumulative or average value of predicted traffic loads in a specific period in the future, but the present invention is not limited to the above form. The user equipment may calculate, estimate or predict the above traffic load through various well-known methods, and may also obtain the traffic load of the user equipment from other devices.

Configuration information can be transmitted by the high altitude platform station to the customer premises equipment. The configuration information may be used to instruct the customer premises equipment to enter an on state or a non-on state, wherein the non-on state at least comprises an off state. The non-on state may also comprise an idle state. The configuration information may also be determined based on the traffic load.

Alternatively, the customer premises equipment 200 may also receive other information, and based on this information, determine that the customer premises equipment enters an on state or a non-on state, which at least comprises an off state. The non-on state may also comprise an idle state. Alternatively, the customer premises equipment 200 may also determine that the customer premises equipment enters an on state or a non-on state according to preset criteria, and the non-on state at least comprises an off state. The non-on state may also comprise an idle state. The preset criteria may be related to the traffic load information or the configuration information of the user equipment, but it is not limited to this, and may also be other information related to the implementation of the customer premises equipment.

According to the customer premises equipment of another embodiment of the present disclosure, in the off state, the control unit 230 determines, when a condition about the customer premises equipment is met, that the customer premises equipment 200 is switched to another state different from the off state.

The other state described above may be one of the on state and the idle state mentioned above, or another state of the customer premises equipment.

The condition about the customer premises equipment may be that the customer premises equipment may set a timer, and if the timer expires, it means that the condition about the customer premises equipment is met.

The condition about the customer premises equipment may also be that the customer premises equipment sets a specific threshold value, and if the traffic load transmitted from the user equipment is greater than or equal to the specific threshold value, it means that the condition about the customer premises equipment is met. Of course, the condition about the customer premises equipment may also be other relations the traffic load transmitted from the user equipment compared with the specific threshold value. The setting of the timer, the threshold value, etc. can be setting by the customer premises equipment itself, or it may be setting by the customer premises equipment based on an instruction of an upper station (such as the high altitude platform station).

According to the customer premises equipment of another embodiment of the present disclosure, the receiving unit is further configured to receive configuration information from the high altitude platform station, and the control unit is further configured to determine in the off state that the customer premises equipment is switched to another state different from the off state according to the configuration information.

The configuration information may also be used to instruct the customer premises equipment to enter the on state, the idle state, or another state different from the off state.

In addition, the receiving unit 210 may also receive the configuration information transmitted from the high altitude platform station through new signaling via DCI, RRC or MAC CE, or receive the configuration information transmitted from the high altitude platform station through F1-AP signaling. It may also be that the configuration information is transmitted from the high altitude platform station as a CU or a host DU (Donor-DU) to the Mobile Terminal (MT) functional module of the customer premises equipment. It may also be that the configuration information is transmitted from the high altitude platform station as the CU to the customer premises equipment as the DU. The receiving unit 210 may also receive the configuration information transmitted from the high altitude platform station through other channels and other signaling.

According to the customer premises equipment of another embodiment of the present disclosure, the off state comprises a full off state, and the control unit is only used in the full off state for determining that the customer premises equipment is switched to another state different from the full off state.

Specifically, in the full off state, the customer premises equipment may also turn off all DU functions and all functions for transmitting and receiving with the user equipment, that is, turn off the transmitting and receiving of uplink and downlink control channels and uplink and downlink data channels with the user equipment including Physical Downlink Shared Channel (PDSCH), Physical Downlink Control Channel (PDCCH), Physical Uplink Shared Channel (PUSCH), Physical Uplink Control Channel (PUCCH), Physical Random Access Channel (PRACH), and other channels, and turn off the transmitting and receiving of uplink and downlink reference signals with the user equipment including Synchronization Signal Block (SSB), Channel State Information-Reference Signal (CSI-RS), Sounding Reference Signal (SRS) and other reference channels.

Alternatively, in the full off state, the customer premises equipment may also turn off all MT functions and all functions of transmitting and receiving with a CU or a host DU (Donor-DU) on the basis of turning off the above functions, that is, turn off the transmitting and receiving of uplink and downlink control channels and uplink and downlink data channels with the CU or the host DU (Donor-DU) including PDSCH, PDCCH, PUSCH, PUCCH, PRACH, and other channels, and turn off the transmitting and receiving of uplink and downlink reference signals with the CU or the host DU (Donor-DU) including SSB, CSI-RS, SRS and other reference channels.

That is to say, in the full off state, at least the functions of the DU of the customer premises equipment are all turned off, so that the customer premises equipment cannot communicate with the user equipment, and the customer premises equipment cannot receive information (such as a scheduling request) transmitted by the user equipment itself, and thus cannot make a corresponding feedback based on the information transmitted by the user equipment itself.

Furthermore, a communication process of the customer premises equipment in the case of the full off state is explained.

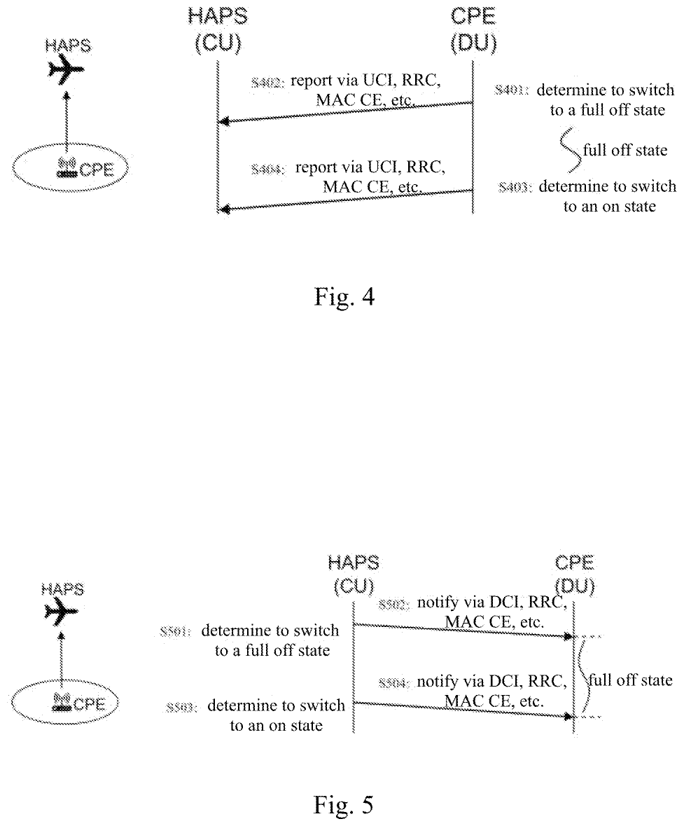

Referring to FIG. 4, an explanation is made with respect to a case where the customer premises equipment in the full off state itself determines to switch to another state different from the full off state.

In FIG. 4, an example of switching to an on state different from the full off state is given, but switching to another state different from the full off state is also possible.

In S401, as described above, the control unit 230 of the customer premises equipment may determine that the customer premises equipment enters the full off state according to at least one of the received traffic load information and the configuration information.

In S402, the customer premises equipment may report to the CU in the high-altitude platform station (that is, report from the MT function in the customer premises equipment to the CU or the host DU) that the customer premises equipment enters the full off state or only report the full off state, through new signaling via UCT, RRC or MAC CE, or the customer premises equipment may also report to the CU in the high altitude platform station (that is, report from the DU to the CU) that the customer premises equipment enters the full off state or only report the full off state, through F1-AP signaling.

The timing of the report may be before the customer premises equipment enters the full off state. That is to say, the customer premises equipment may enter the full off state after transmitting the report, or the customer may enter the full off state after transmitting the report to the high altitude platform station and receiving confirmation information from the high altitude platform station.

The timing of the report may also be after the customer premises equipment enters the full off state. In this case, the customer premises equipment still has a function of transmitting the report to the high altitude platform station in the full off state.

In S403, the customer premises equipment may also determine to switch to another state different from the full off state, such as the on state, when the condition about the customer premises equipment (such as the expiration of the timer) is met.

In S404, the customer premises equipment may report to the CU in the high-altitude platform station (that is, report from the MT function in the customer premises equipment to the CU or the host DU) that the customer premises equipment switches to the other state or only report the other state, through new signaling via UCI, RRC or MAC CE, or the customer premises equipment may also report to the CU in the high altitude platform station (that is, report from the DU to the CU) that the customer premises equipment switches to the other state or only report the other state, through F1-AP signaling.

The timing of the report may be before the customer premises equipment enters the switched other state. That is to say, the customer premises equipment may enter the switched other state after transmitting the report, or the customer may enter the switched other state after transmitting the report to the high altitude platform station and receiving confirmation information from the high altitude platform station.

The timing of the report may also be after the customer premises equipment enters the switched other state. That is, after the customer premises equipment enters the switched other state, the customer premises equipment transmits the report to the high altitude platform station. In this case, the customer premises equipment still has a function of transmitting the report to the high altitude platform station in the other state.

In addition, referring to FIG. 5, an explanation is made with respect to a case where the customer premises equipment in the full off state determines to switch to another state different from the full off state based on the configuration information transmitted by the high altitude platform station.

In FIG. 5, an example of switching to the on state different from the full off state is given, but switching to another state different from the full off state is also possible.

In S501, the control unit 330 of the high altitude platform station may determine that the customer premises equipment enters the full off state.

In S502, the high altitude platform station may transmit to the customer premises equipment (i.e., transmit from the CU or the host DU to the MT function in the customer premises equipment) the configuration information for indicating the customer premises equipment to enter the full off state through new signaling via DCI, RRC or MAC CE, or the high altitude platform station may also transmit to the customer premises equipment (i.e., transmit from the CU to the DU) the configuration information for indicating the customer premises equipment to enter the full off state through F1-AP signaling. After receiving the configuration information, the customer premises equipment determines to enter the full off state according to the configuration information. After that, the customer premises equipment enters the full off state.

In S503, the control unit 330 of the high altitude platform station may also determine that the customer premises equipment enters another state different from the full off state, such as the on state.

In S504, the high altitude platform station may transmit to the customer premises equipment (i.e., transmit from the CU or the host DU to the MT function in the customer premises equipment) configuration information for indicating the customer premises equipment to enter another state different from the full off state through new signaling via DCI, RRC or MAC CE, or the high altitude platform station may also transmit to the customer premises equipment (i.e., transmit from the CU to the DU) the configuration information for indicating the customer premises equipment to enter another state different from the full off state through F1-AP signaling. After receiving the configuration information, the customer premises equipment determines to enter the other state different from the full off state according to the configuration information. After that, the customer premises equipment enters the other state different from the full off state.

As described above, the process that the customer premises equipment determines to enter the full off state based on at least one of the traffic load information or the configuration information, and when the customer premises equipment is in the full off state, the customer premises equipment itself determines to exit from the full off state and enter another state different from the full off state is explained, and the process that the customer premises equipment determines to exit from the full off state and enter another state different from the full off state based on the configuration information transmitted from the high altitude platform station is also explained.

In the case that the customer premises equipment is in the full off state, the customer premises equipment turns off all DU functions and all communication functions for transmitting and receiving with the user equipment, that is, turning off the transmitting and receiving of uplink and downlink control channels and uplink and downlink data channels with the user equipment including PDSCH, PDCCH, PUSCH, PUCCH, PRACH and other channels, and turn off the transmitting and receiving of uplink and downlink reference signals with the user equipment including SSB, CSI-RS, SRS and other reference channels.

Alternatively, in the case that the customer premises equipment is in the full off state, the customer premises equipment turns off all DU functions and all communication functions for transmitting and receiving with the user equipment, that is, turning off the transmitting and receiving of uplink and downlink control channels and uplink and downlink data channels with the user equipment including PDSCH, PDCCH, PUSCH, PUCCH, PRACH and other channels, and turn off the transmitting and receiving of uplink and downlink reference signals with the user equipment including SSB, CSI-RS, SRS and other reference channels. On this basis, the customer premises equipment may also turn off all MT functions and all functions of transmitting and receiving with the CU and the host DU, that is, turn off the transmitting and receiving of uplink and downlink control channels and uplink and downlink data channels with the CU and the host DU including PDSCH, PDCCH, PUSCH, PUCCH, PRACH, and other channels, and turn off the transmitting and receiving of uplink and downlink reference signals with the CU and the host DU including SSB, CSI-RS, SRS and other reference channels.

Therefore, by making the customer premises equipment enter the full off state, the above functions of the customer premises equipment are turned off, and the frequency resources used for this customer premises equipment can be used for other customer premises equipment, which can increase the resource utilization rate and reduce the power consumption. In addition, since the above functions of the customer premises equipment are turned off, communication interference with other customer premises equipment can also be reduced.

According to the customer premises equipment of another embodiment of the present disclosure, the off state comprises a semi-off state, and the customer premises equipment 200 further includes a transmitting unit 220 configured to transmit a reference signal for detecting a traffic load at a predetermined time interval in the semi-off state.

Specifically, in the semi-off state, compared with the full off state, the transmitting unit of the customer premises equipment can transmit the reference signal for detecting the traffic load at the predetermined time interval. However, in the full off state, the transmitting unit of the customer premises equipment cannot transmit the reference signal for detecting the traffic load.

Furthermore, a communication process of the customer premises equipment in the semi-off state is explained.

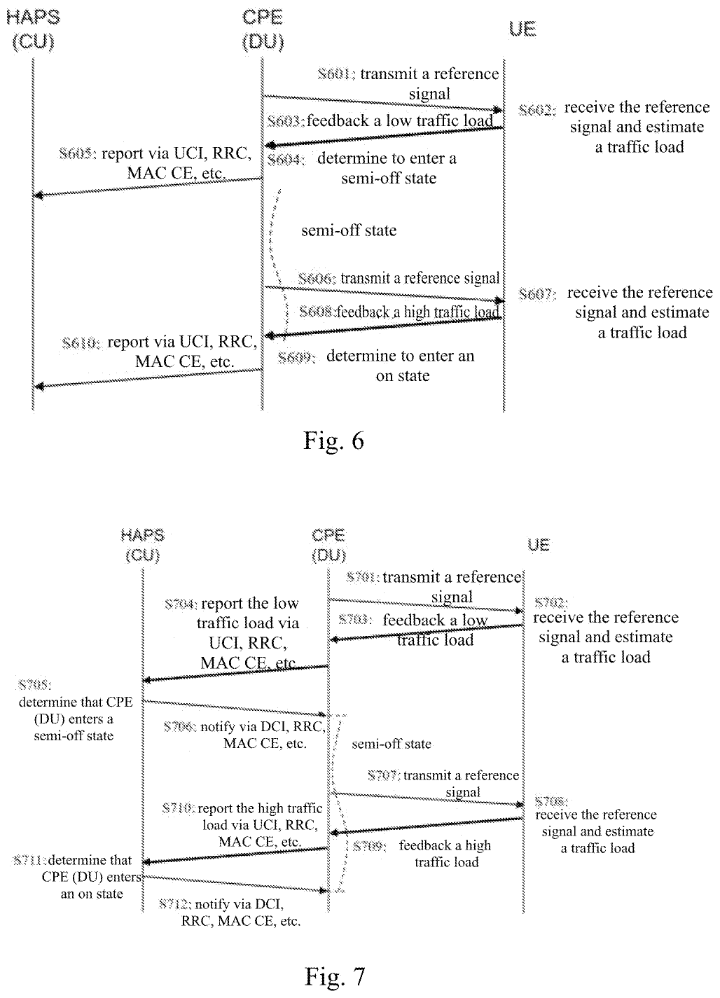

Referring to FIG. 6, an explanation is made with respect to a case where the customer premises equipment in the semi-off state itself determines to switch to another state different from the semi-off state.

In FIG. 6, an example of switching to the on state different from the semi-off state is given, but switching to another state different from the semi-off state is also possible.

In S601, as described above, the transmitting unit 220 of the customer premises equipment may also transmit the reference signal for detecting the traffic load to the user equipment at the predetermined time interval.

The above predetermined time interval may be set by the high altitude platform station or preset by the high altitude platform station.

Further, the reference signal may also be different from reference signals in 3GPP releases 15, 16 and 17. The reference signal may also be SSB, in which case the predetermined time interval for transmitting the SSB may also be longer than the maximum time interval specified in 3GPP releases 15, 16 and 17, that is, it may also be longer than the maximum period.

Alternatively, the reference signal may also be SSB, and be transmitted at a period of 5 ms, 10 ms, 20 ms, 40 ms, 80 ms and 160 ms, and the period of the transmission may also be longer than the above-mentioned period, for example, it may be 320 ms, or may also be transmitted at a longer period.

In S602, the user equipment estimates the traffic load after receiving the reference signal for detecting the traffic load. As described above, the traffic load can be instantaneous, a cumulative value or average value within a period of time, etc., and the present invention is not limited thereto. The traffic load may also be made based on the reference signal.

In S603, if the traffic load estimated by the user equipment is a low traffic load, the traffic load information indicating the low traffic load is fed back to the customer premises equipment.

In S604, the customer premises equipment determines that the customer premises equipment enters a semi-off state according to the received traffic load information.

Specifically, the control unit 230 of the customer premises equipment 200 may also determine that the customer premises equipment 200 enters the semi-off state in a case that the traffic load information is lower than a specific threshold value. The specific threshold value may be set by the customer premises equipment or set based on the information notified by the high altitude platform station. Obviously, the present invention is not limited to that the control unit 230 of the customer premises equipment 200 determines that the customer premises equipment 200 enters the semi-off state only in the case that the traffic load information is lower than the specific threshold value, and the control unit 230 of the customer premises equipment 200 may also determine that the customer premises equipment 200 enters the semi-off state in other cases of the traffic load information compared with the specific threshold value.

In S605, the customer premises equipment may report to the CU in the high altitude platform station (i.e., report from the MT function in the customer premises equipment to the CU or the host DU) that the customer premises equipment enters the semi-off state or only report the semi-off state, via UCI, RRC or MAC CE through new signaling, or the customer premises equipment may also report to the CU in the high altitude platform station (i.e., report from the DU to the CU) that the customer premises equipment enters the semi-off state or only report the semi-off state, through F1-AP signaling.

The timing of the report may be before the customer premises equipment enters the semi-off state. That is to say, the customer premises equipment may enter the semi-off state after transmitting the report, or the customer may enter the semi-off state after transmitting the report to the high altitude platform station and receiving confirmation information from the high altitude platform station.

The timing of the report may also be after the customer premises equipment enters the semi-off state. In this case, the customer premises equipment still has a function of transmitting the report to the high altitude platform station in the semi-off state.

In S606, since the customer premises equipment transmits the reference signal for detecting the traffic load at a predetermined time interval, the customer premises equipment transmits the next reference signal for detecting the traffic load to the user equipment at the predetermined time interval.

In S607, as in S602, the user equipment estimates the traffic load after receiving the reference signal for detecting the traffic load.

In S608, if the traffic load estimated by the user equipment is a high traffic load, the traffic load information indicating the high traffic load is fed back to the customer premises equipment.

In S609, the customer premises equipment determines that the customer premises equipment enters the on state according to the received traffic load information.

Specifically, the control unit 230 of the customer premises equipment 200 may also determine that the customer premises equipment 200 enters the on state in a case that the traffic load information is higher than a specific threshold value. The specific threshold value may be set by the customer premises equipment or be set based on the information notified by the high altitude platform station. Obviously, the present invention is not limited to that the control unit 230 of the customer premises equipment 200 determines that the customer premises equipment 200 enters the on state only in the case that the traffic load information is higher than the specific threshold value, and the control unit 230 of the customer premises equipment 200 may also determine that the customer premises equipment 200 enters the on state in other cases of the traffic load information compared with the specific threshold value.

In S610, the customer premises equipment may report to the CU in the high altitude platform station (i.e., report from the MT function in the customer premises equipment to the CU or the host DU) that the customer premises equipment enters the on state or only report the on state, through new signaling via UCI, RRC or MAC CE, or the customer premises equipment may also report to the CU in the high altitude platform station (i.e., report from the DU to the CU) that the customer premises equipment enters the on state or only report the on state, through F1-AP signaling.

The timing of the report may be before the customer premises equipment enters the on state. That is to say, the customer premises equipment may enter the on state after transmitting the report, or the customer may enter the on state after transmitting the report to the high altitude platform station and receiving confirmation information from the high altitude platform station.

The timing of the report may also be after the customer premises equipment enters the on state.

In addition, it is explained in S609 that the customer premises equipment determines that the customer premises equipment enters the on state according to the received traffic load information. However, the customer premises equipment may also determine that the customer premises equipment enters another state different from the semi-off state according to the received traffic load information. That is, the customer premises equipment may also determine that the customer premises equipment exits from the semi-off state according to the received traffic load information.

In this case, as described above, in S610, the customer premises equipment may also report to the CU in the high altitude platform station (that is, report from the MT function in the customer premises equipment to the CU or the host DU) that the customer premises equipment enters the other state different from the semi-off state or only report the other state, through new signaling via UCI, RRC or MAC CE, or the customer premises equipment may also report to the CU in the high altitude platform station (that is, report from the DU to the CU) that the customer premises equipment enters the other state different from the semi-off state or only report the other state, through F1-AP signaling.

Next, referring to FIG. 7, an explanation is made with respect to a case where the customer premises equipment in a semi-off state determines to switch to another state different from the semi-off state based on configuration information transmitted from the high altitude platform station. For ease of reading, the same steps as in FIG. 6 are briefly explained.

An example of switching to the on state different from the semi-off state is given in FIG. 7, but switching to other states different from the semi-off state is also possible.

In S701, as in S601, the transmitting unit 220 of the customer premises equipment may also transmit the reference signal for detecting the traffic load to the user equipment at a predetermined time interval.

In S702, the user equipment estimates the traffic load after receiving the reference signal for detecting the traffic load.

In S703, if the traffic load estimated by the user equipment is a low traffic load, the traffic load information indicating the low traffic load is fed back to the customer premises equipment.

In S704, the customer premises equipment transmits a traffic load report to the high altitude platform station based on the received traffic load information. The traffic load report may also represent the traffic load information received by the customer premises equipment.

In S704, the customer premises equipment may transmit the traffic load report to the CU in the high altitude platform station (i.e., report from the MT function in the customer premises equipment to the CU or the host DU) through new signaling via UCI, RRC, or MAC CE, or the customer premises equipment may transmit the traffic load report to the CU in the high altitude platform station (i.e., report from the DU to the CU) through F1-AP signaling.

In S705, the high altitude platform station determines that the customer premises equipment enters the semi-off state.

In S706, the CU in the high altitude platform station may indicate to the customer premises equipment (i.e., notify from the CU or the host DU to the MT function in the customer premises equipment) that the customer premises equipment enters the semi-off state or only notify of the semi-off state, through new signaling via DCI, RRC, or MAC CE, and the CU the high altitude platform station may also indicate to the customer premises equipment (i.e., notify from the CU to the DU) that the customer premises equipment enters the semi-off state or only notify of the semi-off state, through F1-AP signaling. The customer premises equipment enters the semi-off state based on the indication of entering the semi-off state or the notified semi-off state.

In S707, since the customer premises equipment transmits the reference signal for detecting the traffic load at a predetermined time interval in the semi-off state, the customer premises equipment in the semi-off state transmits the next reference signal for detecting the traffic load to the user equipment at the predetermined time interval.

In S708, as in step S702, the user equipment estimates the traffic load after receiving the reference signal for detecting the traffic load.

In S709, if the traffic load estimated by the user equipment is a high traffic load, the traffic load information indicating the high traffic load is fed back to the customer premises equipment.

In S710, the customer premises equipment transmits a traffic load report to the high altitude platform station based on the received traffic load information. The traffic load report may also represent the traffic load information received by the customer premises equipment

In S710, the customer premises equipment may transmit the traffic load report to the CU in the high altitude platform station (i.e., report from the MT function in the customer premises equipment to the CU or the host DU) through new signaling via UCI, RRC, or MAC CE, or the customer premises equipment may transmit the traffic load report to the CU in the high altitude platform station (i.e., report from the DU to the CU) through F1-AP signaling.

In S711, the high altitude platform station determines that the customer premises equipment enters the on state.

In S712, the CU in the high altitude platform station may transmit to the customer premises equipment (i.e., notify from the CU or the host DU to the MT function in the customer premises equipment) configuration information for indicating the customer premises equipment to enter the on state or for only notifying of the on state, through new signaling via DCI, RRC, or MAC CE, and the CU the high altitude platform station may also transmit to the customer premises equipment (i.e., notify from the CU to the DU) the configuration information for indicating the customer premises equipment to enter the on state or for only notifying of the on state, through F1-AP signaling. The customer premises equipment enters the on state based on the indication of entering the on state or the notified on state.

Furthermore, it is explained in S712 that the high altitude platform station determines that the customer premises equipment enters the on state based on the received traffic load information. However, the high altitude platform station may also determine that the customer premises equipment enters another state different from the semi-off state based on the received traffic load information. That is, the high altitude platform station may also determine that the customer premises equipment exits from the semi-off state based on the received traffic load information.

In this case, as described above, in S712, the CU in the high altitude platform station may transmit to the customer premises equipment (i.e., transmit from the CU or the host DU to the MT function in the customer premises equipment) configuration information for indicating the customer premises equipment to enter another state different from the semi-off state or for only reporting the other state, through new signaling via DCI, RRC, or MAC CE, or the CU the high altitude platform station may also transmit to the customer premises equipment (i.e., report from the CU to the DU) the configuration information for indicating the customer premises equipment to enter another state different from the semi-off state or for only reporting the other state, through F1-AP signaling.

As above, the process that the customer premises equipment determines to enter the semi-off state based on at least one of the traffic load information or the configuration information, and when the customer premises equipment is in the semi-off state, the customer premises equipment itself determines to exit from the semi-off state and enter another state different from the semi-off state is explained, and the process that the customer premises equipment determines to exit from the semi-off state and enter another state different from the semi-off state based on the configuration information transmitted from the high altitude platform station is also explained.

The functions turned off by the customer premises equipment in the semi-off state are substantially the same as the functions turned off by the customer premises equipment in the full off state, but in the semi-off state, the transmitting unit of the customer premises equipment is capable of transmitting the reference signal for detecting the traffic load at a predetermined time interval.

Accordingly, by causing the customer premises equipment to enter the semi-off state, the transmitting unit of the customer premises equipment is capable of transmitting the reference signal for detecting the traffic load at a predetermined time interval in the semi-off state, and thus it is possible to detect semi-static and dynamic changes in the traffic load faster in the semi-off state as compared to the full off state, so that it is possible to respond to such changes faster, thereby providing lower transmission latency. At the same time, some of the communication functions of the customer premises equipment in the semi-off state are still turned off as compared to the full off state, and thus, to a certain extent, frequency resources used for this customer premises equipment can also be used for other customer premises equipment, which can increase the resource utilization rate and can also reduce the power consumption. In addition, since some of the communication functions of the customer premises equipment are turned off, it is also possible to reduce communication interference with other customer premises equipment.

Thus, by further defining the off state as the semi-off state and the full off state, it is possible to respond more flexibly to situations with different traffic loads.

A high altitude platform station (HAPS) according to an embodiment of the present disclosure is explained referring to FIG. 3. FIG. 3 is a schematic diagram of the high altitude platform station of an embodiment of the present disclosure. As shown in FIG. 3, the high altitude platform station 300 has a receiving unit 310, a transmitting unit 320, and a control unit 330.

An high altitude platform station according to an embodiment of the present disclosure includes: a control unit configured to determine that a customer premises equipment enters an on state or a non-on state, wherein the non-on state at least comprises an off state; and a transmitting unit configured to transmit configuration information for indicating the customer premises equipment to enter the on state or the non-on state. As described above, the off state may also comprise a semi-off state and a full off state. The non-on state may also comprise an idle state.

The transmitting unit 320 may also transmit to the customer premises equipment (i.e., transmit from the CU or the host DU to the MT function in the customer premises equipment) the configuration information for indicating the customer premises equipment to enter the on state or the non-on state through new signaling via DCI, RRC or MAC CE, or the CU in the high altitude platform station may also transmit to the customer premises equipment (i.e., report from the CU to the DU) the configuration information for indicating the customer premises equipment to enter the on state or the non-on state through F1-AP signaling. The non-on state at least comprises an off state. The non-on state may also comprise an idle state.

A high altitude platform station according to an embodiment of the present disclosure further includes a receiving unit 310 that receives a traffic load report transmitted from the customer premises equipment 200, and the control unit 330 determines that customer premises equipment 200 enters the on state or the non-on state based on the traffic load report. The high altitude platform station 300 generates, based on the traffic load report transmitted from the customer premises equipment 200, configuration information based on the traffic load report, and transmits the generated configuration information to the customer premises equipment 200. The non-on state at least comprises an off state. The non-on state may also comprise an idle state.

The high altitude platform station 300 may also generate the configuration information without based on the traffic load report transmitted from the customer premises equipment 200.

The idle state of the customer premises equipment 200 was mentioned in the above explanation, and the idle state is explained in detail below.

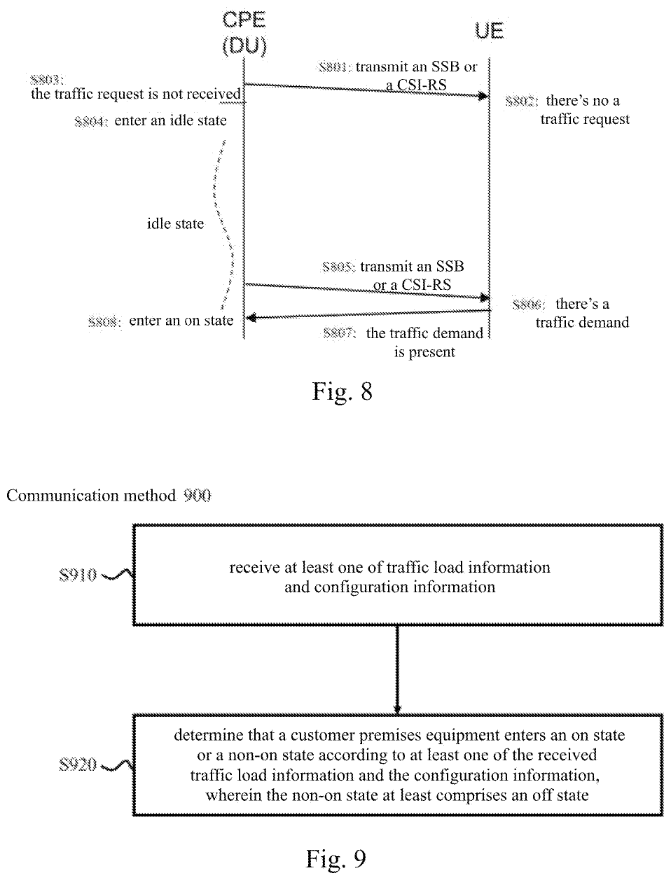

First, referring to FIG. 8, an explanation is made with respect to a case where the customer premises equipment in the idle state itself determines to switch to another state different from the idle state.

An example of switching to the on state different from the idle state is given in FIG. 8, but switching to another state different from the idle state is also possible.

In S801, the transmitting unit 220 of the customer premises equipment may also transmit an SSB or a CSI-RS for detecting the traffic load to the user equipment, at a predetermined time interval. The SSB or the CSI-RS is the same as that used for an initial access in the NR.

The predetermined time interval described above may be set by the high altitude platform station or may be preset by the high altitude platform station.

The transmitting time interval of the SSB or CSI-RS may also be greater than the maximum time interval specified in 3GPP releases 15, 16, and 17, i.e., greater than the maximum period.

In S802, the user equipment estimates the traffic load after receiving the SSB or CSI-RS for detecting the traffic load. As described above, the traffic load may be instantaneous, a cumulative value or an average value within a period of time, etc., and the present invention is not limited thereto. The traffic load may also be made based on the reference signal.

In S802, since the user equipment estimates that there is no traffic load, no traffic request is transmitted to the customer premises equipment.

In S803, since the customer premises equipment does not receive the traffic request transmitted by the user equipment at a specific timing, it is determined that there is no traffic load for the user equipment, and thus, the customer premises equipment determines to enter the idle state.

The functions turned off by the customer premises equipment in the idle state are substantially the same as compared to the functions turned off by the customer premises equipment in the full off state, however, the customer premises equipment in the idle state is able to transmit the SSB or the CSI-RS to the user equipment.

As shown in FIG. 8, the customer premises equipment in the idle state transmits the SSB or the CSI-RS for detecting the traffic load to the user equipment at a predetermined time interval.

That is, in S805, the customer premises equipment transmits the next SSB or CSI-RS for detecting the traffic load to the user equipment at the predetermined time interval.

In S806, the user equipment estimates the traffic load after receiving the SSB or the CSI-RS for detecting the traffic load.

As in S802, the estimated traffic load may be instantaneous, a cumulative value or an average value within a period of time, etc., and the present invention is not limited thereto. The traffic load may also be made based on the reference signal.

In S807, the user equipment feeds the traffic demand to the customer premises equipment in the case where the presence of the traffic load is estimated.

In S808, the customer premises equipment determines that the customer premises equipment enters the on state according to the received traffic demand.

Specifically, the control unit 230 of the customer premises equipment 200 may also determine that the customer premises equipment 200 enters the on state in a case that the traffic load information is higher than a specific threshold value. The specific threshold value may be set by the customer premises equipment or may be set based on information notified by the high altitude platform station. Obviously, the present invention is not limited to that the control unit 230 of the customer premises equipment 200 determines that the customer premises equipment 200 enters the on state only in the case that the traffic load information is higher than the specific threshold value, and the control unit 230 of the customer premises equipment 200 may also determine that the customer premises equipment 200 enters the on state in other cases of the traffic load information compared with the specific threshold value.

Furthermore, it is explained in S808 that the customer premises equipment determines that the customer premises equipment enters the on state according to the received traffic load information. However, the customer premises equipment may also determine that the customer premises equipment enters another state different from the idle state according to the received traffic load information. That is, the customer premises equipment may also determine that the customer premises equipment exits from the idle state according to the received traffic load information.

In addition, the entry from the idle state into the other state different from the idle state, and the entry from the other state different from the idle state into the idle state may also be not reported to the high altitude platform station.

Accordingly, by causing the customer premises equipment to enter the idle state, the transmitting unit of the customer premises equipment is capable of transmitting the SSB or CSI-RS for detecting the traffic load at a predetermined time interval in the idle state, and thus it is possible to detect semi-static and dynamic changes in the traffic load faster and respond to such changes, thereby providing lower transmission latency. At the same time, some of the communication functions of the customer premises equipment in the idle state are still turned off as compared to the full off state, and thus, to a certain extent, frequency resources used for this customer premises equipment can also be used for other customer premises equipment, which can increase the resource utilization rate, and can also reduce the power consumption. In addition, since some of the communication functions of the customer premises equipment are turned off, it is also possible to reduce communication interference with other customer premises equipment.

Furthermore, since the reference signal for detecting the traffic load uses the same SSB or CSI-RS as the NR, it is possible to increase the compatibility with a present NR system.

Furthermore, in the above explanation of the embodiments, examples, for example, where the customer premises equipment enters the full off state and switches from the full off state to the on state are explained in FIGS. 4 and 5, and examples where the customer premises equipment enters a semi-off state and switches from a semi-off state to the on state are explained in FIGS. 6 and 7, and an example where the customer premises equipment enters the idle state and switches from the idle state to the on state is explained in FIG. 8.

However, the switching between the four states (i.e., the on state, the idle state, the semi-off state, and the full off state) described above, is not limited to the examples of the state switching described above. The customer premises equipment may also switch from one of the above states to other states different from this state. That is, it is possible for arbitrary switching between the four states of the invention, thereby enabling more flexible configuration of the state of the customer premises equipment.

In addition, instead of supporting arbitrary switching between the four states, the customer premises equipment can also support only the state switching illustrated in FIGS. 4 to 8, i.e., only support that the customer premises equipment enters the full off state and switches from the full off state to the on state, the customer premises equipment enters the semi-off state and switches from the semi-off state to the on state, and the customer premises equipment enters the idle state and switches from the idle state to the on state, thereby enabling simplicity and low cost of the configuration within the customer premises equipment.

Furthermore, the customer premises equipment may also support the switching between some of the four states described above. It is also possible to support the switching only between a particular state to the on state and a state adjacent to that particular state. For example, the full off state may also be switched to the semi-off state and the on state, the semi-off state may also be switched to the idle state and the on state, and the idle state may also be switched to the on state, and so on. As a result, it is possible to flexibly configure the state of the customer premises equipment while achieving simplicity and low cost of the configuration within the customer premises equipment to a certain extent.

In addition, the state switching described above may also be performed separately for each band domain. That is, the state switching of the customer premises equipment are performed separately for each band domain based on the traffic load and interference. A case where the state switching is performed based on the traffic load is described as an example below.

For example, as described above, a common threshold value is set for each band domain, and the state switching of the customer premises equipment is controlled separately for each band domain based on the process described in the above-described embodiments.

It is also possible to set respective threshold value for each band domain, and similarly control the state switching of the customer premises equipment separately for each band domain based on the process illustrated in the above-described embodiments.

It is also possible to set a total threshold value for all the band domains, and control the state switching for all the band domains based on the relationship between the sum of the traffic loads of respective band domains and the total threshold value. For example, in a case where the sum of the traffic loads of respective band domains is greater than the total threshold value, the customer premises equipment is switched to the on state for all band domains. In a case where the sum of the traffic loads of respective band domains is below the total threshold value, the customer premises equipment is switches to, for example, the off state for all band domains.

As described above, the switching of the specific states described above is only an example, and the switching between respective states is arbitrary.

Furthermore, with regard to the above-described full off state, semi-off state, and idle state, from the viewpoint of energy efficiency, the energy efficiency of the customer premises equipment in the full off state is greater than the energy efficiency of the customer premises equipment in the semi-off state, and the energy efficiency of the customer premises equipment in the semi-off state is greater than the energy efficiency of the customer premises equipment in the idle state.

From the viewpoint of transmission delay, the transmission delay of the customer premises equipment in the idle state is less than the transmission delay of the customer premises equipment in the semi-off state, and the transmission delay of the customer premises equipment in the semi-off state is less than the transmission delay of the customer premises equipment in the full off state.

The communication flow among the customer premises equipment, the user equipment, and the high altitude platform station according to an embodiment of the present invention is explained above in conjunction with FIGS. 4 to 8. In the above explanation, it is explained in a manner of dividing into individual units, such as, for example, the control unit, the receiving unit, the transmitting unit, and the like, however, it can also be explained in a manner of dividing into individual steps, i.e., the communication flow among the customer premises equipment, the user equipment, and the high altitude platform station of FIGS. 4 to 8 is explained in a manner of a controlling step, a receiving step, and a transmitting step.

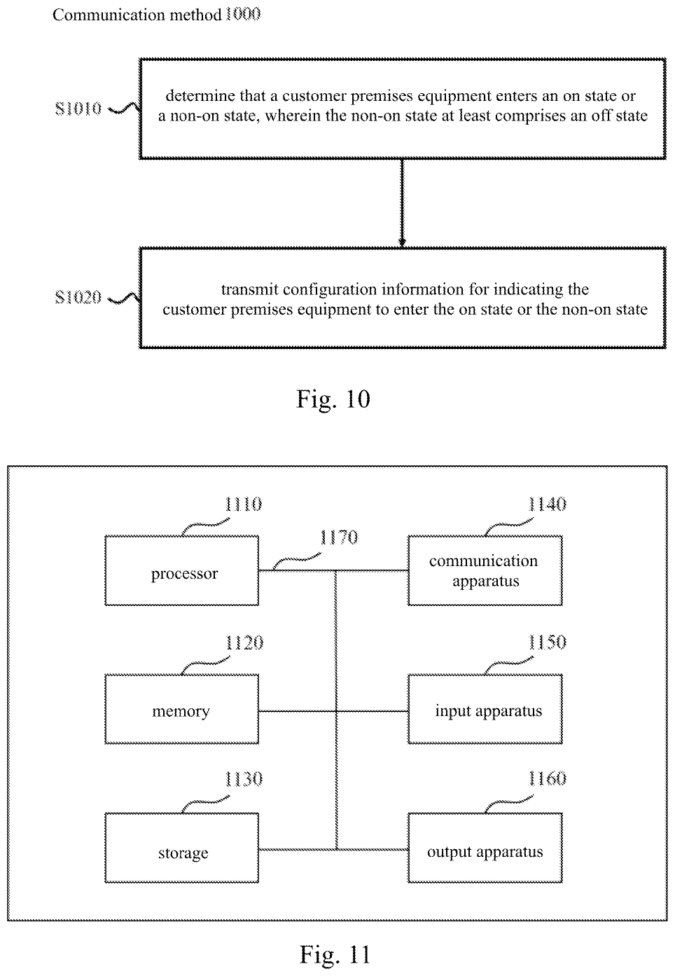

In the following, a communication method executed by the customer premises equipment and a communication method executed by the high altitude platform station are explained in conjunction with the flowcharts (FIGS. 4 to 8) and the schematic diagrams (FIGS. 9 and 10).

Next, a communication method executed by customer premises equipment (CPE) according to an embodiment of the present disclosure is explained with reference to FIG. 9. FIG. 9 is a schematic diagram of the communication method executed by the customer premises equipment according to an embodiment of the present disclosure.

As shown in FIG. 9, the communication method 900 executed by the customer premises equipment includes a step S910 and a step S920. In the S910, at least one of traffic load information and configuration information is received, and it is determined that the customer premises equipment enters an on state or a non-on state, according to at least one of the received traffic load information and configuration information, wherein the non-on state at least comprises an off state. The non-on state may also comprise an idle state.

The traffic load information may be sent from the user equipment to the customer premises equipment, which may represent an instantaneous traffic load of the user equipment at a current time, a traffic load at a specific time, or a cumulative or average value of traffic loads in a specific period. For example, the cumulative or average value of the traffic loads in a period after the current time may also indicate a predicted traffic load at a specific time in the future, and may also indicate a cumulative or average value of predicted traffic loads in a specific period in the future, but the present invention is not limited to the above form. The user equipment may calculate, estimate or predict the above traffic load through various well-known methods, and may also obtain the traffic load of the user equipment from other devices.

Configuration information can be transmitted by the high altitude platform station to the customer premises equipment. The configuration information may be used to instruct the customer premises equipment to enter an on state or a non-on state, wherein the non-on state at least comprises an off state. The non-on state may also comprise an idle state. The configuration information may also be determined based on the traffic load.

Alternatively, the customer premises equipment may also receive other information, and based on this information, determine that the customer premises equipment enters an on state or a non-on state, which at least comprises an off state. The non-on state may also comprise an idle state. Alternatively, the customer premises equipment may also determine that the customer premises equipment enters an on state or a non-on state according to preset criteria, and the non-on state at least comprises an off state. The non-on state may also comprise an idle state. The preset criteria may be related to the traffic load information or the configuration information of the user equipment, but it is not limited to this, and may also be other information related to the implementation of the customer premises equipment.

The communication method executed by the customer premises equipment according to another embodiment of the present disclosure further includes: in the off state, the determining, when a condition about the customer premises equipment is met, that the customer premises equipment is switched to another state different from the off state.

The other state described above may be one of the on state and the idle state mentioned above, or another state of the customer premises equipment.

The condition about the customer premises equipment may be that the customer premises equipment may set a timer, and if the timer expires, it means that the condition about the customer premises equipment is met.

The condition about the customer premises equipment may also be that the customer premises equipment sets a specific threshold value, and if the traffic load transmitted from the user equipment is greater than or equal to the specific threshold value, it means that the condition about the customer premises equipment is met. Of course, the condition about the customer premises equipment may also be other relations the traffic load transmitted from the user equipment compared with the specific threshold value. The setting of the timer, the threshold value, etc. can be setting by the customer premises equipment itself, or it may be setting by the customer premises equipment based on an instruction of an upper station (such as the high altitude platform station).

The communication method executed by the customer premises equipment according to another embodiment of the present disclosure further includes: receiving configuration information from the high altitude platform station, and determining in the off state that the customer premises equipment is switched to another state different from the off state according to the configuration information.

The configuration information may also be used to instruct the customer premises equipment to enter the on state, the idle state, or another state different from the off state.

In addition, the customer premises equipment may also receive the configuration information transmitted from the high altitude platform station through new signaling via DCI, RRC or MAC CE, or receive the configuration information transmitted from the high altitude platform station through F1-AP signaling. It may also be that the configuration information is transmitted from the high altitude platform station as a CU or a host DU (Donor-DU) to the Mobile Terminal (MT) functional module of the customer premises equipment. It may also be that the configuration information is transmitted from the high altitude platform station as the CU to the customer premises equipment as the DU. The customer premises equipment may also receive the configuration information transmitted from the high altitude platform station through other channels and other signaling.

The communication method executed by the customer premises equipment according to another embodiment of the present disclosure further includes the following step: the off state including a full off state, only determining in the full off state that the customer premises equipment is switched to another state different from the full off state.

Specifically, in the full off state, the customer premises equipment may also turn off all DU functions and all functions for transmitting and receiving with the user equipment, that is, turn off the transmitting and receiving of uplink and downlink control channels and uplink and downlink data channels with the user equipment including PDSCH, PDCCH, PUSCH, PUCCH, PRACH, and other channels, and turn off the transmitting and receiving of uplink and downlink reference signals with the user equipment including SSB, CSI-RS, SRS and other reference channels.

Alternatively, in the full off state, the customer premises equipment may also turn off all MT functions and all functions of transmitting and receiving with a CU or a host DU (Donor-DU) on the basis of turning off the above functions, that is, turn off the transmitting and receiving of uplink and downlink control channels and uplink and downlink data channels with the CU or the host DU (Donor-DU) including PDSCH, PDCCH, PUSCH, PUCCH, PRACH, and other channels, and turn off the transmitting and receiving of uplink and downlink reference signals with the CU or the host DU (Donor-DU) including SSB, CSI-RS, SRS and other reference channels.

That is to say, in the full off state, at least the functions of the DU of the customer premises equipment are all turned off, so that the customer premises equipment cannot communicate with the user equipment, and the customer premises equipment cannot receive information (such as a scheduling request) transmitted by the user equipment itself, and thus cannot make a corresponding feedback based on the information transmitted by the user equipment itself.

Furthermore, a communication process of the customer premises equipment in the case of the full off state is explained.

First, referring to FIG. 4, an explanation is made with respect to a case where the customer premises equipment in the full off state itself determines to switch to another state different from the full off state.

In FIG. 4, an example of switching to an on state different from the full off state is given, but switching to another state different from the full off state is also possible.

In S401, as described above, the customer premises equipment may determine that the customer premises equipment enters the full off state according to at least one of the received traffic load information and the configuration information.

In S402, the customer premises equipment may report to the CU in the high-altitude platform station (that is, report from the MT function in the customer premises equipment to the CU or the host DU) that the customer premises equipment enters the full off state or only report the full off state, through new signaling via UCI, RRC or MAC CE, or the customer premises equipment may also report to the CU in the high altitude platform station (that is, report from the DU to the CU) that the customer premises equipment enters the full off state or only report the full off state, through F1-AP signaling.

The timing of the report may be before the customer premises equipment enters the full off state. That is to say, the customer premises equipment may enter the full off state after transmitting the report, or the customer may enter the full off state after transmitting the report to the high altitude platform station and receiving confirmation information from the high altitude platform station.

The timing of the report may also be after the customer premises equipment enters the full off state. In this case, the customer premises equipment still has a function of transmitting the report to the high altitude platform station in the full off state.

In S403, the customer premises equipment may also determine to switch to another state different from the full off state, such as the on state, when the condition about the customer premises equipment (such as the expiration of the timer) is met.

In S404, the customer premises equipment may report to the CU in the high-altitude platform station (that is, report from the MT function in the customer premises equipment to the CU or the host DU) that the customer premises equipment switches to the other state or only report the other state, through new signaling via UCI, RRC or MAC CE, or the customer premises equipment may also report to the CU in the high altitude platform station (that is, report from the DU to the CU) that the customer premises equipment switches to the other state or only report the other state, through F1-AP signaling.

The timing of the report may be before the customer premises equipment enters the switched other state. That is to say, the customer premises equipment may enter the switched other state after transmitting the report, or the customer may enter the switched other state after transmitting the report to the high altitude platform station and receiving confirmation information from the high altitude platform station.

The timing of the report may also be after the customer premises equipment enters the switched other state. That is, after the customer premises equipment enters the switched other state, the customer premises equipment transmits the report to the high altitude platform station. In this case, the customer premises equipment still has a function of transmitting the report to the high altitude platform station in the other state.

In addition, referring to FIG. 5, an explanation is made with respect to a case where the customer premises equipment in the full off state determines to switch to another state different from the full off state based on the configuration information transmitted by the high altitude platform station.

In FIG. 5, an example of switching to the on state different from the full off state is given, but switching to another state different from the full off state is also possible.

In S501, the high altitude platform station may determine that the customer premises equipment enters the full off state.

In S502, the high altitude platform station may transmit to the customer premises equipment (i.e., transmit from the CU or the host DU to the MT function in the customer premises equipment) the configuration information for indicating the customer premises equipment to enter the full off state through new signaling via DCI, RRC or MAC CE, or the high altitude platform station may also transmit to the customer premises equipment (i.e., transmit from the CU to the DU) the configuration information for indicating the customer premises equipment to enter the full off state through F1-AP signaling. After receiving the configuration information, the customer premises equipment determines to enter the full off state according to the configuration information. After that, the customer premises equipment enters the full off state.

In S503, the high altitude platform station may also determine that the customer premises equipment enters another state different from the full off state, such as the on state.

In S504, the high altitude platform station may transmit to the customer premises equipment (i.e., transmit from the CU or the host DU to the MT function in the customer premises equipment) configuration information for indicating the customer premises equipment to enter another state different from the full off state through new signaling via DCI, RRC or MAC CE, or the high altitude platform station may also transmit to the customer premises equipment (i.e., transmit from the CU to the DU) the configuration information for indicating the customer premises equipment to enter another state different from the full off state through F1-AP signaling. After receiving the configuration information, the customer premises equipment determines to enter the other state different from the full off state according to the configuration information. After that, the customer premises equipment enters the other state different from the full off state.

As described above, the process that the customer premises equipment determines to enter the full off state based on at least one of the traffic load information or the configuration information, and when the customer premises equipment is in the full off state, the customer premises equipment itself determines to exit from the full off state and enter another state different from the full off state is explained, and the process that the customer premises equipment determines to exit from the full off state and enter another state different from the full off state based on the configuration information transmitted from the high altitude platform station is also explained.

In the case that the customer premises equipment is in the full off state, the customer premises equipment turns off all DU functions and all communication functions for transmitting and receiving with the user equipment, that is, turning off the transmitting and receiving of uplink and downlink control channels and uplink and downlink data channels with the user equipment including PDSCH, PDCCH, PUSCH, PUCCH, PRACH and other channels, and turn off the transmitting and receiving of uplink and downlink reference signals with the user equipment including SSB, CSI-RS, SRS and other reference channels.

Alternatively, in the case that the customer premises equipment is in the full off state, the customer premises equipment turns off all DU functions and all communication functions for transmitting and receiving with the user equipment, that is, turning off the transmitting and receiving of uplink and downlink control channels and uplink and downlink data channels with the user equipment including PDSCH, PDCCH, PUSCH, PUCCH, PRACH and other channels, and turn off the transmitting and receiving of uplink and downlink reference signals with the user equipment including SSB, CSI-RS, SRS and other reference channels. On this basis, the customer premises equipment may also turn off all MT functions and all functions of transmitting and receiving with the CU and the host DU, that is, turn off the transmitting and receiving of uplink and downlink control channels and uplink and downlink data channels with the CU and the host DU including PDSCH, PDCCH, PUSCH, PUCCH, PRACH, and other channels, and turn off the transmitting and receiving of uplink and downlink reference signals with the CU and the host DU including SSB, CSI-RS, SRS and other reference channels.

Therefore, by making the customer premises equipment enter the full off state, the above functions of the customer premises equipment are turned off, and the frequency resources used for this customer premises equipment can be used for other customer premises equipment, which can increase the resource utilization rate and reduce the power consumption. In addition, since the above functions of the customer premises equipment are turned off, communication interference with other customer premises equipment can also be reduced.

The communication method executed by the customer premises equipment according to another embodiment of the present disclosure further includes: the off state including a semi-off state, and in the semi-off state, transmitting a reference signal for detecting a traffic load at a predetermined time interval.

Specifically, in the semi-off state, compared with the full off state, the customer premises equipment can transmit the reference signal for detecting the traffic load at the predetermined time interval. However, in the full off state, the customer premises equipment cannot transmit the reference signal for detecting the traffic load.

Furthermore, a communication process of the customer premises equipment in the semi-off state is explained.

Referring to FIG. 6, an explanation is made with respect to a case where the customer premises equipment in the semi-off state itself determines to switch to another state different from the semi-off state.

In FIG. 6, an example of switching to the on state different from the semi-off state is given, but switching to another state different from the semi-off state is also possible.

In S601, as described above, the customer premises equipment may also transmit the reference signal for detecting the traffic load to the user equipment at the predetermined time interval.

The above predetermined time interval may be set by the high altitude platform station or preset by the high altitude platform station.

Further, the reference signal may also be different from reference signals in 3GPP releases 15, 16 and 17. The reference signal may also be SSB, in which case the predetermined time interval for transmitting the SSB may also be longer than the maximum time interval specified in 3GPP releases 15, 16 and 17, that is, it may also be longer than the maximum period.

In S602, the user equipment estimates the traffic load after receiving the reference signal for detecting the traffic load. As described above, the traffic load can be instantaneous, a cumulative value or average value within a period of time, etc., and the present invention is not limited thereto. The traffic load may also be made based on the reference signal.

In S603, if the traffic load estimated by the user equipment is a low traffic load, the traffic load information indicating the low traffic load is fed back to the customer premises equipment.

In S604, the customer premises equipment determines that the customer premises equipment enters a semi-off state according to the received traffic load information.

Specifically, the customer premises equipment may also determine that the customer premises equipment enters the semi-off state in a case that the traffic load information is lower than a specific threshold value. The specific threshold value may be set by the customer premises equipment or set based on the information notified by the high altitude platform station. Obviously, the present invention is not limited to that the customer premises equipment determines that the customer premises equipment enters the semi-off state only in the case that the traffic load information is lower than the specific threshold value, and the customer premises equipment may also determine that the customer premises equipment enters the semi-off state in other cases of the traffic load information compared with the specific threshold value.

In S605, the customer premises equipment may report to the CU in the high altitude platform station (i.e., report from the MT function in the customer premises equipment to the CU or the host DU) that the customer premises equipment enters the semi-off state or only report the semi-off state, via UCI, RRC or MAC CE through new signaling, or the customer premises equipment may also report to the CU in the high altitude platform station (i.e., report from the DU to the CU) that the customer premises equipment enters the semi-off state or only report the semi-off state, through F1-AP signaling.

The timing of the report may be before the customer premises equipment enters the semi-off state. That is to say, the customer premises equipment may enter the semi-off state after transmitting the report, or the customer may enter the semi-off state after transmitting the report to the high altitude platform station and receiving confirmation information from the high altitude platform station.

The timing of the report may also be after the customer premises equipment enters the semi-off state. In this case, the customer premises equipment still has a function of transmitting the report to the high altitude platform station in the semi-off state.

In S606, since the customer premises equipment transmits the reference signal for detecting the traffic load at a predetermined time interval, the customer premises equipment transmits the next reference signal for detecting the traffic load to the user equipment at the predetermined time interval.

In S607, as in S602, the user equipment estimates the traffic load after receiving the reference signal for detecting the traffic load.

In S608, if the traffic load estimated by the user equipment is a high traffic load, the traffic load information indicating the high traffic load is fed back to the customer premises equipment.

In S609, the customer premises equipment determines that the customer premises equipment enters the on state according to the received traffic load information.

Specifically, the customer premises equipment may also determine that the customer premises equipment enters the on state in a case that the traffic load information is higher than a specific threshold value. The specific threshold value may be set by the customer premises equipment or be set based on the information notified by the high altitude platform station. Obviously, the present invention is not limited to that the customer premises equipment determines that the customer premises equipment enters the on state only in the case that the traffic load information is higher than the specific threshold value, and the customer premises equipment may also determine that the customer premises equipment enters the on state in other cases of the traffic load information compared with the specific threshold value.

In S610, the customer premises equipment may report to the CU in the high altitude platform station (i.e., report from the MT function in the customer premises equipment to the CU or the host DU) that the customer premises equipment enters the on state or only report the on state, through new signaling via UCI, RRC or MAC CE, or the customer premises equipment may also report to the CU in the high altitude platform station (i.e., report from the DU to the CU) that the customer premises equipment enters the on state or only report the on state, through F1-AP signaling.

The timing of the report may be before the customer premises equipment enters the on state. That is to say, the customer premises equipment may enter the on state after transmitting the report, or the customer may enter the on state after transmitting the report to the high altitude platform station and receiving confirmation information from the high altitude platform station.

The timing of the report may also be after the customer premises equipment enters the on state.

In addition, it is explained in S609 that the customer premises equipment determines that the customer premises equipment enters the on state according to the received traffic load information. However, the customer premises equipment may also determine that the customer premises equipment enters another state different from the semi-off state according to the received traffic load information. That is, the customer premises equipment may also determine that the customer premises equipment exits from the semi-off state according to the received traffic load information.

In this case, as described above, in S610, the customer premises equipment may also report to the CU in the high altitude platform station (that is, report from the MT function in the customer premises equipment to the CU or the host DU) that the customer premises equipment enters the other state different from the semi-off state or only report the other state, through new signaling via UCI, RRC or MAC CE, or the customer premises equipment may also report to the CU in the high altitude platform station (that is, report from the DU to the CU) that the customer premises equipment enters the other state different from the semi-off state or only report the other state, through F1-AP signaling.

Next, referring to FIG. 7, an explanation is made with respect to a case where the customer premises equipment in a semi-off state determines to switch to another state different from the semi-off state based on configuration information transmitted from the high altitude platform station. For ease of reading, the same steps as in FIG. 6 are briefly explained.

An example of switching to the on state different from the semi-off state is given in FIG. 7, but switching to other states different from the semi-off state is also possible.

In S701, as in S601, the customer premises equipment may also transmit the reference signal for detecting the traffic load to the user equipment at a predetermined time interval.

In S702, the user equipment estimates the traffic load after receiving the reference signal for detecting the traffic load.

In S703, if the traffic load estimated by the user equipment is a low traffic load, the traffic load information indicating the low traffic load is fed back to the customer premises equipment.

In S704, the customer premises equipment transmits a traffic load report to the high altitude platform station based on the received traffic load information. The traffic load report may also represent the traffic load information received by the customer premises equipment.

In S704, the customer premises equipment may transmit the traffic load report to the CU in the high altitude platform station (i.e., report from the MT function in the customer premises equipment to the CU or the host DU) through new signaling via UCI, RRC, or MAC CE, or the customer premises equipment may transmit the traffic load report to the CU in the high altitude platform station (i.e., report from the DU to the CU) through F1-AP signaling.

In S705, the high altitude platform station determines that the customer premises equipment enters the semi-off state.

In S706, the CU in the high altitude platform station may indicate to the customer premises equipment (i.e., notify from the CU or the host DU to the MT function in the customer premises equipment) that the customer premises equipment enters the semi-off state or only notify of the semi-off state, through new signaling via DCI, RRC, or MAC CE, and the CU the high altitude platform station may also indicate to the customer premises equipment (i.e., notify from the CU to the DU) that the customer premises equipment enters the semi-off state or only notify of the semi-off state, through F1-AP signaling. The customer premises equipment enters the semi-off state based on the indication of entering the semi-off state or the notified semi-off state.

In S707, since the customer premises equipment transmits the reference signal for detecting the traffic load at a predetermined time interval in the semi-off state, the customer premises equipment in the semi-off state transmits the next reference signal for detecting the traffic load to the user equipment at the predetermined time interval.

In S708, as in step S702, the user equipment estimates the traffic load after receiving the reference signal for detecting the traffic load.

In S709, if the traffic load estimated by the user equipment is a high traffic load, the traffic load information indicating the high traffic load is fed back to the customer premises equipment.

In S710, the customer premises equipment transmits a traffic load report to the high altitude platform station based on the received traffic load information. The traffic load report may also represent the traffic load information received by the customer premises equipment

In S710, the customer premises equipment may transmit the traffic load report to the CU in the high altitude platform station (i.e., report from the MT function in the customer premises equipment to the CU or the host DU) through new signaling via UCI, RRC, or MAC CE, or the customer premises equipment may transmit the traffic load report to the CU in the high altitude platform station (i.e., report from the DU to the CU) through F1-AP signaling.

In S711, the high altitude platform station determines that the customer premises equipment enters the on state.

In S712, the CU in the high altitude platform station may transmit to the customer premises equipment (i.e., notify from the CU or the host DU to the MT function in the customer premises equipment) configuration information for indicating the customer premises equipment to enter the on state or for only notifying of the on state, through new signaling via DCI, RRC, or MAC CE, and the CU the high altitude platform station may also transmit to the customer premises equipment (i.e., notify from the CU to the DU) the configuration information for indicating the customer premises equipment to enter the on state or for only notifying of the on state, through F1-AP signaling. The customer premises equipment enters the on state based on the indication of entering the on state or the notified on state.

Furthermore, it is explained in S712 that the high altitude platform station determines that the customer premises equipment enters the on state based on the received traffic load information. However, the high altitude platform station may also determine that the customer premises equipment enters another state different from the semi-off state based on the received traffic load information. That is, the high altitude platform station may also determine that the customer premises equipment exits from the semi-off state based on the received traffic load information.

In this case, as described above, in S712, the CU in the high altitude platform station may transmit to the customer premises equipment (i.e., transmit from the CU or the host DU to the MT function in the customer premises equipment) configuration information for indicating the customer premises equipment to enter another state different from the semi-off state or for only reporting the other state, through new signaling via DCI, RRC, or MAC CE, or the CU the high altitude platform station may also transmit to the customer premises equipment (i.e., report from the CU to the DU) the configuration information for indicating the customer premises equipment to enter another state different from the semi-off state or for only reporting the other state, through F1-AP signaling.

As above, the process that the customer premises equipment determines to enter the semi-off state based on at least one of the traffic load information or the configuration information, and when the customer premises equipment is in the semi-off state, the customer premises equipment itself determines to exit from the semi-off state and enter another state different from the semi-off state is explained, and the process that the customer premises equipment determines to exit from the semi-off state and enter another state different from the semi-off state based on the configuration information transmitted from the high altitude platform station is also explained.

The functions turned off by the customer premises equipment in the semi-off state are substantially the same as the functions turned off by the customer premises equipment in the full off state, but in the semi-off state, the transmitting unit of the customer premises equipment is capable of transmitting the reference signal for detecting the traffic load at a predetermined time interval.

Accordingly, by causing the customer premises equipment to enter the semi-off state, the customer premises equipment is capable of transmitting the reference signal for detecting the traffic load at a predetermined time interval in the semi-off state, and thus it is possible to detect semi-static and dynamic changes in the traffic load faster in the semi-off state as compared to the full off state, so that it is possible to respond to such changes faster, thereby providing lower transmission latency. At the same time, some of the communication functions of the customer premises equipment in the semi-off state are still turned off as compared to the full off state, and thus, to a certain extent, frequency resources used for this customer premises equipment can also be used for other customer premises equipment, which can increase the resource utilization rate and can also reduce the power consumption. In addition, since some of the communication functions of the customer premises equipment are turned off, it is also possible to reduce communication interference with other customer premises equipment.

Thus, by further defining the off state as the semi-off state and the full off state, it is possible to respond more flexibly to situations with different traffic loads.

A communication method executed by the high altitude platform station (HAPS) according to an embodiment of the present disclosure is explained referring to FIG. 10. FIG. 10 is a schematic diagram of the communication method executed by the high altitude platform station of an embodiment of the present disclosure. As shown in FIG. 10, the communication method 1000 executed by the high altitude platform station includes step S1010 and step S1020. In the step S1010, it is determined that a customer premises equipment enters an on state or a non-on state, wherein the non-on state at least comprises an off state; and in the step S1020, configuration information for indicating the customer premises equipment to enter the on state or the non-on state is transmitted. As described above, the off state may also comprise a semi-off state and a full off state. The non-on state may also comprise an idle state.

The high altitude platform station may also transmit to the customer premises equipment (i.e., transmit from the CU or the host DU to the MT function in the customer premises equipment) the configuration information for indicating the customer premises equipment to enter the on state or the non-on state through new signaling via DCI, RRC or MAC CE, or the CU in the high altitude platform station may also transmit to the customer premises equipment (i.e., transmit from the CU to the DU) the configuration information for indicating the customer premises equipment to enter the on state or the non-on state through F1-AP signaling. The non-on state at least comprises an off state. The non-on state may also comprise an idle state.

The communication method executed by the high altitude platform station according to an embodiment of the present disclosure further includes: receiving a traffic load report transmitted from the customer premises equipment, and determining that customer premises equipment enters the on state or the non-on state based on the traffic load report. The high altitude platform station generates, based on the traffic load report transmitted from the customer premises equipment, configuration information based on the traffic load report, and transmits the generated configuration information to the customer premises equipment. The non-on state at least comprises an off state. The non-on state may also comprise an idle state. The high altitude platform station may also generate the configuration information without based on the traffic load report transmitted from the customer premises equipment.

The idle state of the customer premises equipment was mentioned in the above explanation for the communication method, and the communication flow for the idle state is explained in detail below.

Referring to FIG. 8, an explanation is made with respect to a case where the customer premises equipment in the idle state determines to switch to another state different from the idle state.

An example of switching to the on state different from the idle state is given in FIG. 8, but switching to another state different from the idle state is also possible.

In S801, the customer premises equipment may also transmit an SSB or a CSI-RS for detecting the traffic load to the user equipment, at a predetermined time interval. The SSB or the CSI-RS is the same as that used for an initial access in the NR.

The predetermined time interval described above may be set by the high altitude platform station or may be preset by the high altitude platform station.

The transmitting time interval of the SSB or CSI-RS may also be greater than the maximum time interval specified in 3GPP releases 15, 16, and 17, i.e., greater than the maximum period.

In S802, the user equipment estimates the traffic load after receiving the SSB or CSI-RS for detecting the traffic load. As described above, the traffic load may be instantaneous, a cumulative value or an average value within a period of time, etc., and the present invention is not limited thereto. The traffic load may also be made based on the reference signal.

In S802, since the user equipment estimates that there is no traffic load, no traffic request is transmitted to the customer premises equipment.

In S803, since the customer premises equipment does not receive the traffic request transmitted by the user equipment at a specific timing, it is determined that there is no traffic load for the user equipment, and thus, the customer premises equipment determines to enter the idle state.

The functions turned off by the customer premises equipment in the idle state are substantially the same as compared to the functions turned off by the customer premises equipment in the full off state, however, the customer premises equipment in the idle state is able to transmit the SSB or the CST-RS to the user equipment.

As shown in FIG. 8, the customer premises equipment in the idle state transmits the SSB or the CSI-RS for detecting the traffic load to the user equipment at a predetermined time interval.

That is, in S805, the customer premises equipment transmits the next SSB or CSI-RS for detecting the traffic load to the user equipment at the predetermined time interval.

In S806, the user equipment estimates the traffic load after receiving the SSB or the CSI-RS for detecting the traffic load.

As in S802, the estimated traffic load may be instantaneous, a cumulative value or an average value within a period of time, etc., and the present invention is not limited thereto. The traffic load may also be made based on the reference signal.

In S807, the user equipment feeds the traffic demand to the customer premises equipment in the case where the presence of the traffic load is estimated.

In S808, the customer premises equipment determines that the customer premises equipment enters the on state according to the received traffic demand.

Specifically, the customer premises equipment may also determine that the customer premises equipment enters the on state in a case that the traffic load information is higher than a specific threshold value. The specific threshold value may be set by the customer premises equipment or may be set based on information notified by the high altitude platform station. Obviously, the present invention is not limited to that the customer premises equipment determines that the customer premises equipment enters the on state only in the case that the traffic load information is higher than the specific threshold value, and the customer premises equipment may also determine that the customer premises equipment enters the on state in other cases of the traffic load information compared with the specific threshold value.

Furthermore, it is explained in S808 that the customer premises equipment determines that the customer premises equipment enters the on state according to the received traffic load information. However, the customer premises equipment may also determine that the customer premises equipment enters another state different from the idle state according to the received traffic load information. That is, the customer premises equipment may also determine that the customer premises equipment exits from the idle state according to the received traffic load information.

In addition, the entry from the idle state into the other state different from the idle state, and the entry from the other state different from the idle state into the idle state may also be not reported to the high altitude platform station.

Accordingly, by causing the customer premises equipment to enter the idle state, the customer premises equipment is capable of transmitting the SSB or CSI-RS for detecting the traffic load at a predetermined time interval in the idle state, and thus it is possible to detect semi-static and dynamic changes in the traffic load faster and respond to such changes, thereby providing lower transmission latency. At the same time, some of the communication functions of the customer premises equipment in the idle state are still turned off as compared to the full off state, and thus, to a certain extent, frequency resources used for this customer premises equipment can also be used for other customer premises equipment, which can increase the resource utilization rate, and can also reduce the power consumption. In addition, since some of the communication functions of the customer premises equipment are turned off, it is also possible to reduce communication interference with other customer premises equipment.

Furthermore, since the reference signal for detecting the traffic load uses the same SSB or CSI-RS as the NR, it is possible to increase the compatibility with a present NR system.

### <Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. wired and/or wirelessly), and the respective functional blocks may be implemented by these apparatuses.

For example, a device (such as a terminal, a base station, etc.) in an embodiment of the present disclosure may function as a computer that executes the processes of the wireless communication method of the present disclosure. FIG. 11 is a schematic diagram of a hardware structure of a device 1100 according to an embodiment of the present disclosure. The above device 1100 may be constituted as a computer apparatus that physically comprises a processor 1110, a memory 1120, a storage 1130, a communication apparatus 1140, an input apparatus 1150, an output apparatus 1160, a bus 1170 and the like

In addition, in the following description, terms such as “apparatus” may be replaced with circuits, devices, units, and the like. The hardware structure of the user equipment may include one or more of the respective apparatuses shown in the figure, or may not include a part of the apparatuses.

For example, only one processor 1110 is illustrated, but there may be multiple processors. Furthermore, processes may be performed by one processor, or processes may be performed by more than one processor simultaneously, sequentially, or with other methods. In addition, the processor 1100 may be installed by more than one chip.

Various functions of the device 1100 may be implemented, for example, by reading specified software (program) on hardware such as the processor 1110 and the memory 1120, so that the processor 1110 performs computations, controls communication performed by the communication apparatus 1140, and controls reading and/or writing of data in the memory 1120 and the storage 1130.

The processor 1110, for example, operates an operating system to control the entire computer. The processor 1110 may be constituted by a Central Processing Unit (CPU), which includes interfaces with peripheral apparatuses, a control apparatus, a computing apparatus, a register and the like. For example, the processing unit described above may be implemented by the processor 1110.

In addition, the processor 1110 reads programs (program codes), software modules, data and the like from the storage 1130 and/or the communication apparatus 1140 to the memory 1120, and execute various processes according to them. As for the program, a program causing computers to execute at least a part of the operations described in the above embodiments may be employed. For example, the processing unit of the terminal may be implemented by a control program stored in the memory 1120 and operated by the processor 1110, and other functional blocks may also be implemented similarly.

The memory 1120 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 1120 may also be referred to as a register, a cache, a main memory (a main storage apparatus) and the like. The memory 1120 may store executable programs (program codes), software modules and the like for implementing a method involved in an embodiment of the present disclosure.

The storage 1130 is a computer-readable recording medium, and may be constituted, for example, by at least one of a flexible disk, a Floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 1130 may also be referred to as an auxiliary storage apparatus.

The communication apparatus 1140 is a hardware (transceiver device) performing communication between computers via a wired and/or wireless network, and is also referred to as a network device, a network controller, a network card, a communication module and the like, for example. The communication apparatus 1140 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 1140.

The communication apparatus 1150 is an input device (e.g., a keyboard, a mouse, a microphone, a switch, a button, a sensor and the like) that receives input from the outside. The output apparatus 1160 is an output device (e.g., a display, a speaker, a Light Emitting Diode (LED) light and the like) that performs outputting to the outside. In addition, the communication apparatus 1150 and the output apparatus 1160 may also be an integrated structure (e.g., a touch panel).

Furthermore, the respective apparatuses such as the processor 1110 and the memory 1120 are connected by the bus 1170 that communicates information. The bus 1170 may be constituted by a single bus or by different buses between the apparatuses.

Furthermore, the terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and a part of or all of the respective functional blocks may be implemented by the hardware. For example, the processor 1110 may be installed by at least one of these hardware.

### (Variations)

In addition, terms illustrated in the present specification and/or terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

Names used for parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

Information, signals and the like described in this specification may be represented by using any of a variety of different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

Information, signals and the like that are input or output may be stored in a specific location (for example, in a memory), or may be managed through a management table. Information, signals and the like that are input or output may be overwritten, updated or appended. Information, signals and the like that are output may be deleted. Information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, Downlink Control Information (DCI), Uplink Control Information (UCI)), higher layer signaling (for example, Radio Resource Control (RRC) signaling, broadcast information (Master Information Blocks (MIBs), System Information Blocks (SIBs), etc.), Medium Access Control (MAC) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC Control Elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user equipment. For example, for a structure in which communication between a wireless base station and a user equipment is replaced with communication between a plurality of user equipments (Device-to-Device, D2D), the respective manners/embodiments of the present disclosure may also be applied. In this case, the functions provided by the first communication device or the second communication device in the device 1100 can be regarded as the functions provided by a user equipment. Furthermore, the words “uplink” and “downlink” may also be replaced with “side”. For example, an uplink channel may be replaced with a side channel.

Also, a user equipment in this specification may be replaced with a wireless base station. In this case, functions provided by the above user equipment may be regarded as functions provided by a first communication device or a second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched to use during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi®), IEEE 920.16 (WiMAX®), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A customer premises equipment (CPE), comprising:
a receiving unit configured to receive at least one of traffic load information and configuration information;
a control unit configured to determine that the customer premises equipment enters an on state or a non-on state according to at least one of the traffic load information and the configuration information,
wherein the non-on state at least comprises an off state.

2. The customer premises equipment according to claim 1, wherein,
in the off state, the control unit determines, when a condition about the customer premises equipment is met, that the customer premises equipment is switched to another state different from the off state.

3. The customer premises equipment according to claim 1, wherein,
the receiving unit is further configured to receive the configuration information from a high altitude platform station, and
the control unit is further configured to determine in the off state that the customer premises equipment is switched to another state different from the off state according to the configuration information.

4. The customer premises equipment according to claim 1, wherein,
the off state comprises a full off state,
the control unit is only used in the full off state for determining that the customer premises equipment is switched to another state different from the full off state.

5. The customer premises equipment according to claim 1, wherein,
the off state comprises a semi-off state,
the customer premises equipment further comprises:
a transmitting unit configured to transmit a reference signal for detecting a traffic load at a predetermined time interval in the semi-off state.

6. The customer premises equipment according to claim 5, wherein,
in the semi-off state, the transmitting unit is further configured to transmit a traffic load report to a high altitude platform station according to the traffic load information.

7. The customer premises equipment according to claim 3, further comprising:
a transmitting unit configured to transmit, after the control unit determines that the customer premises equipment is switched from the off state to the other state different from the off state or after the control unit determines that the customer premises equipment is switched from the other state different from the off state to the off state, information indicating the switched state to the high altitude platform station.

8. The customer premises equipment according to claim 3, wherein,
the customer premises equipment is configured as a distributed unit (DU),
the high altitude platform station is configured as a central unit (CU).

9. A high altitude platform station (HAPS), comprising:
a control unit configured to determine that a customer premises equipment enters an on state or a non-on state, wherein the non-on state at least comprises an off state;
a transmitting unit configured to transmit configuration information for indicating the customer premises equipment to enter the on state or the non-on state.

10. The high altitude platform station according to claim 9, further comprising:
a receiving unit configured to receive a traffic load report transmitted from the customer premises equipment,
the control unit determines that the customer premises equipment enters the on state or the non-on state based on the traffic load report.
